(19) United States
(12) Patent Application Publication
(10) Pub. No.: US 2022/0381090 A1
(43) Pub. Date: Dec. 1, 2022

(54) LADDER ASSEMBLY AND METHOD FOR ASSEMBLING THE SAME

(71) Applicants: Architectural Systems, Inc., Monett, MO (US); RM Industries, Purdy, MO (US)

(72) Inventors: Michael S. Graves, Monett, MO (US); Michael Eric Saloga, Monett, MO (US); Scott James Beckwith, Monett, MO (US); Michael Lynn Roller, Purdy, MO (US)

(21) Appl. No.: 17/804,035

(22) Filed: May 25, 2022

Related U.S. Application Data
(60) Provisional application No. 63/202,074, filed on May 26, 2021.

(51) Int. Cl. E06C 9/08

(52) U.S. Cl. CPC E06C 9/08; E04H 4/144

(57) ABSTRACT

A ladder assembly includes a mounting plate and a ladder rotatably connected to the mounting plate. The mounting plate includes a body that includes a first surface having a first orientation and a second surface having a second, different orientation, and the mounting plate includes spaced apart brackets attached to the first surface. The ladder includes first and second legs, steps, and a handrail. Each leg extends from a first end to a second end, is rotatably connected to one of the brackets at the first end, and has opposing side surfaces and opposing front and back surfaces. The steps are supported transversely between the legs. The handrail is attached to the front surface of the first leg. The ladder is rotatable between a first position and a second position. The back surface of each leg abuts the second surface of the mounting plate body in the first position.

### CROSS-REFERENCE TO RELATED APPLICATIONS

This application claims the benefit of priority to U.S. Provisional Application Ser. No. 63/202,074, filed on May 26, 2021, the disclosure of which is hereby incorporated by reference in its entirety.

### FIELD OF DISCLOSURE

The field of the disclosure relates generally to a ladder assembly, and more particularly, to a ladder assembly including a mounting plate and a ladder rotatably connected to the mounting plate.

### BACKGROUND

Dock ladders are known for use in accessing bodies of water. Some known dock ladders are rotatably mounted to a side of a dock. A rotatable dock ladder offers the convenience of being able to position the ladder in the water for entering or exiting the water and, when the ladder is not in use, positioning the ladder outside of the water to prevent wear or other damage to the ladder. However, conventional rotatable dock ladders may be difficult to rotate due to ladder design, weight, and other factors. In this regard, conventional rotatable dock ladders may require an additional system, such as a pulley system, to facilitate rotation of the ladder. Moreover, conventional rotatable ladders may require additional measures to safely store the ladder in a stored position. Other disadvantages associated with conventional dock ladders may also exist.

Accordingly, there is a need for a ladder assembly that facilitates rotation of a ladder between in-use and stored positions without the need for additional equipment and, additionally, releasably locks the dock ladder in the stored position.

### BRIEF DESCRIPTION

In one aspect, a ladder assembly includes a mounting plate adapted to be secured to a supporting platform and a ladder connected to the mounting plate. The mounting plate includes a body, the body includes a first planar surface having a first orientation and a second planar surface having a second, different orientation, and the mounting plate further includes a pair of spaced apart brackets attached to the first surface. The ladder is rotatable relative to the mounting plate about an axis, and the ladder includes a first leg, a second leg, a plurality of steps, and a handrail. Each leg of the ladder extends from a first end to a second end, each leg is rotatably connected to one of the brackets at the first end, and each leg has opposing side surfaces and opposing front and back surfaces. The steps are supported transversely between a side surface of the first leg and a side surface of the second leg, and the steps join the first and second legs. The handrail is attached to the front surface of the first leg. The ladder is rotatable between a first position, where the back surface of each leg abuts the second surface of the mounting plate body, and a second position, where the back surface of each leg is spaced from the second surface of the mounting plate body.

In another aspect, kit for a ladder assembly includes a mounting plate adapted to be secured to a supporting platform, first and second legs of a ladder, and steps for joining the first and second legs. The mounting plate includes a body, the body includes a first planar surface having a first orientation and a second planar surface having a second, different orientation, and the mounting plate further includes a pair of spaced apart brackets attached to the first surface. The first and second legs each extend from a first end to a second end, each leg has opposing side surfaces and opposing front and back surfaces, and each leg includes a lip extending outward from the back surface at the first end. The lip of each leg is rotatably attachable to one of the spaced apart brackets.

In another aspect, a method for assembling a ladder assembly includes securing a mounting plate to a supporting platform. The mounting plate includes a body, the body includes a first planar surface having a first orientation and a second planar surface having a second, different orientation, and the mounting plate further includes a pair of spaced apart brackets attached to the first surface. The method also includes attaching a plurality of transverse structures to each of a first leg and a second leg, thereby joining the first and second legs together. Each leg extends from a first end to a second end, and each leg has a front surface and an opposing back surface. The method further includes attaching a handrail to the front surface of the first leg. The method also includes rotatably connecting the first end of each leg to a respective one of the brackets, and rotating the legs relative to the mounting plate about an axis to a position where the back surface of each leg abuts the second surface of the mounting plate.

### BRIEF DESCRIPTION OF THE DRAWINGS

FIG. 1 is a perspective view of an example ladder assembly according to an embodiment of the present disclosure, shown mounted onto a platform.

FIG. 2 is an exploded view of a mounting plate of the ladder assembly shown in FIG. 1.

FIG. 3 is an exploded view of a ladder of the ladder assembly shown in FIG. 1, the ladder being rotatably connectable to the mounting plate shown in FIG. 2.

FIG. 4 is a perspective view of the ladder assembly shown in FIG. 1, illustrating the ladder in a raised position.

FIG. 5 is a perspective view of the ladder assembly shown in FIG. 1, illustrating the ladder in a lowered position.

FIG. 6 is a side view of the ladder assembly shown in FIG. 1.

FIG. 7 is a flowchart of an example method for assembling a ladder assembly according to an embodiment of the present disclosure.

### DETAILED DESCRIPTION

Embodiments of the subject matter described herein relate to assemblies that include vertical or inclined structures mounted onto an elevated platform and rotatable relative to the platform. In particular, embodiments of the subject matter described herein relate to ladders mounted onto a dock or side platform adjacent to a body of water (e.g., a lake, swimming pool, and the like). The ladders are rotatable relative to the dock or side platform between a lowered position in which the ladder is located at least partially in the body of water and enables a user to enter into and exit the body of water using the ladder, and a raised position in which the ladder is located outside of the body of water for situations where the ladder is not in use. Advantageously, the embodiments disclosed herein facilitate rotation of the ladder between the raised and lowered positions without the need for additional equipment (e.g., a pulley system, motor, actuator, or other auxiliary equipment to facilitate rotation of the ladder). For example, in some embodiments, a ladder may be light enough that various users can manually rotate the ladder between the raised and lowered positions with relative ease. However, additional equipment may be used to facilitate rotation of the ladder without departing from the scope of the present disclosure. In some embodiments, for example, a relatively low-powered motor, such as a servo-motor, may be used in conjunction with the ladder assembly to facilitation rotation of the ladder. Additionally, in some embodiments, a ladder includes ergonomic features that facilitation manual rotation of the ladder. These and other advantages may be understood and appreciated as the detailed description proceeds. Furthermore, it should be appreciated that embodiments may include rotatable structures other than ladders without departing from the subject matter of the present disclosure. For example, the subject matter described herein may suitably be used to provide a ramp mounted onto an elevated platform and rotatable relative to the platform. Moreover, the subject matter described herein may be suitable for use with any type of elevated platform. Non-limiting examples of platforms contemplated for use with the present disclosure include, in addition to those described above, mobile and stationary work platforms, loading docks, roofs, vehicle tailgates, hunting blinds, and the like.

Unless otherwise indicated, approximating language, such as “generally,” “substantially,” and “about,” as used herein indicates that the term so modified may apply to only an approximate degree, as would be recognized by one of ordinary skill in the art, rather than to an absolute or perfect degree. Accordingly, a value modified by a term or terms such as “about,” “approximately,” and “substantially” is not to be limited to the precise value specified. In at least some instances, the approximating language may correspond to the precision of an instrument for measuring the value. Here and throughout the specification and claims, range limitations may be identified. Such ranges may be combined and/or interchanged, and include all the sub-ranges contained therein unless context or language indicates otherwise. Additionally, unless otherwise indicated, the terms “first,” “second,” etc. are used herein merely as labels, and are not intended to impose ordinal, positional, or hierarchical requirements on the items to which these terms refer. Moreover, reference to, for example, a “second” item does not require or preclude the existence of, for example, a “first” or lower-numbered item or a “third” or higher-numbered item.

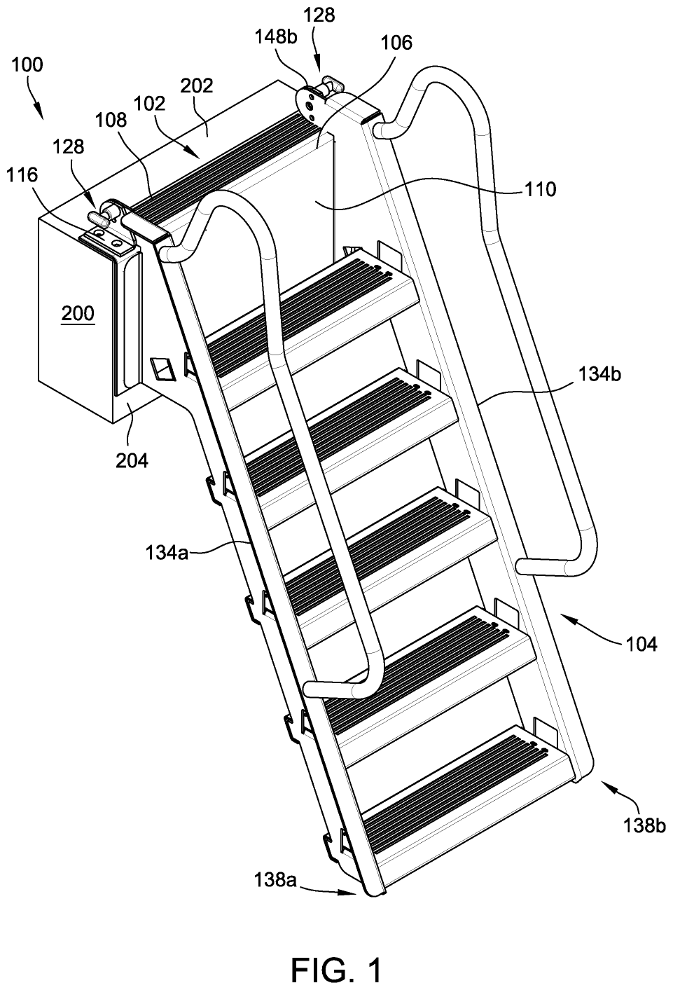

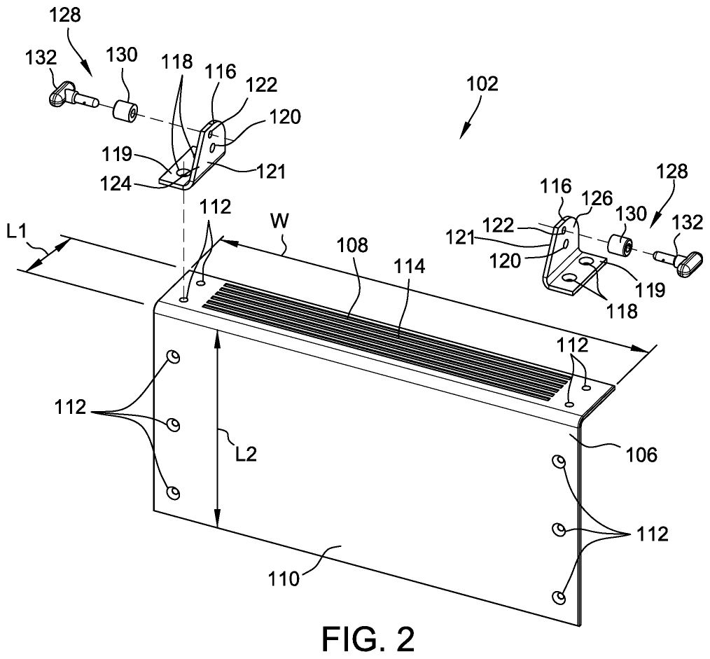

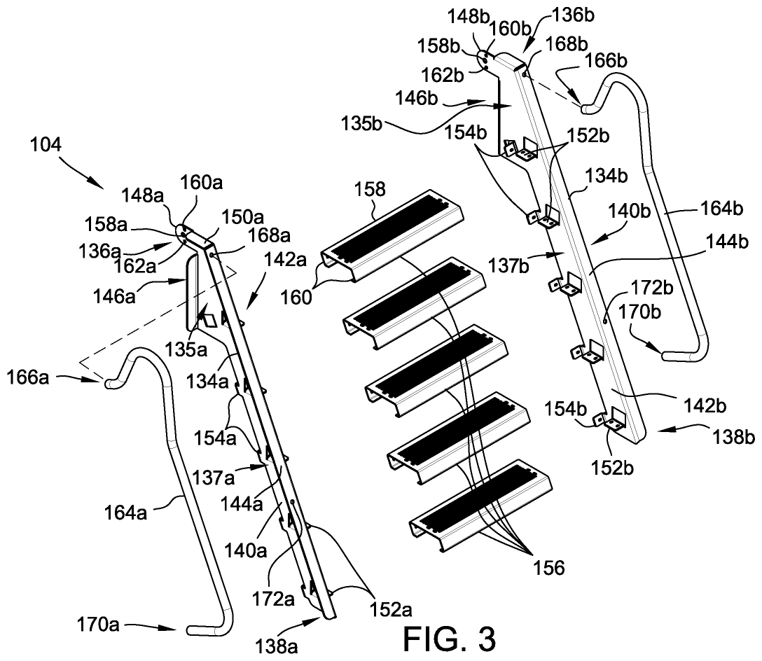

Referring now to the drawings, an example ladder assembly is shown and indicated generally in its entirety at 100. FIG. 1 is a perspective view of the ladder assembly 100, shown mounted onto a platform 200. The ladder assembly includes a mounting plate 102 and a ladder 104. FIG. 2 is an exploded view of the mounting plate 102. FIG. 3 is an exploded view of the ladder 104.

The mounting plate 102 includes a body 106 that is sized and shaped to be mounted onto the platform 200. In one example, the platform 200 may be a platform located adjacent a body of water, such as a lake dock or swimming pool ledge, for example. In the example embodiment, the mounting plate 102 includes an L-shaped body 106 that conforms to a rectangular edge of the platform 200 at an intersection of a first platform surface 202 and a second platform surface 204. It should be appreciated that the body 106 may have any shape to suitably be mounted onto the platform 200 and enable the mounting plate 102 to function as described herein. In general, the body 106 is shaped so that, when the mounting plate 102 is mounted onto the platform 200, the body 106 is in contact with both the first platform surface 202 and the second platform surface 204. Further, the first platform surface 202 is suitably a top surface of the platform 200 and the second platform surface 204 is suitably a side surface of the platform 200.

The mounting plate body 106 includes a first surface 108 and a second surface 110. Each of the first surface 108 and second surface 110 are planar surfaces and externally oriented relative to the platform 200. The first surface 108 extends over at least a portion of the first platform surface 202 and the second surface 110 extends over at least a portion of the second platform surface 204. As such, the first surface 108 and the second surface 110 are oriented in different directions. In the example embodiment, the first surface 108 and the second surface 110 are oriented perpendicular to each other. However, the relative orientations of the first surface 108 and the second surface 110 depend on the shape of the body 106, and therefore are not limited to any specific relative orientation. For example, the first surface 108 may be oriented at an oblique angle relative to the second surface 110, such as at an acute angle or at an obtuse angle. Further, when the mounting plate 102 is mounted onto the platform 200, the first surface 108 suitably defines a top surface of the mounting plate body 106 and the second surface 110 suitably defines a side surface of the mounting plate body 106. The first surface 108 as the top surface supports a load when the ladder assembly 100 is used and may include treads 114 to facilitate preventing a user from slipping when using the ladder assembly 100.

The mounting plate body 106 is secured to the platform 200 via fasteners (not shown), such as bolts or screws, for example. Suitably, to facilitate proper load distribution when the ladder 104 is used, the mounting plate body 106 is secured to the front platform surface 202 and the second platform surface 204. As shown in FIG. 3, in the example embodiment, the mounting plate body 106 has a plurality of holes 112 extending through the body. The mounting plate body 106 receives the fasteners through each of the holes 112 to secure the plate body 106 to the platform 200. Each hole 112 is formed at one side of the plate body 106 on either the first surface 108 or the second surface 110 and is paired with a hole 112 formed at an opposite side of the plate body 106 on the same surface 108 or 110. In the example embodiment, two pairs of holes 112 are formed on the first surface 108 and three pairs of holes 112 are formed on the second surface 110. As such, the mounting plate 102 is secured to the platform 200 at ten attachment locations. However, the number of holes 112 formed on each of the first surface 108 and second surface 110, and the number of attachment locations for securing the mounting plate 102 to the platform 200, is not limited and may vary based on a length that each surface extends over the respective first platform surface 202 and second platform surface 204. Holes (not shown) may be drilled into the first platform surface 202 and the second platform surface 204, and the holes so drilled align with the holes 112 to receive the fasteners and secure the mounting plate 102 to the platform 200. In some examples, the aligning holes drilled into the first and second platform surfaces 202 and 204 are drilled through structure steel supports (not shown) of the platform 200 to facilitate load support when the ladder assembly 100 is used. The fasteners are suitably long enough to extend through the holes 112 and the holes drilled into the first and second platform surfaces 202 and 204, and the fasteners may extend through the platform 200 and be secured to an opposite side of the platform 200 using, for example, a flange nut having serrations. In other embodiments, the mounting plate body 106 may be secured to the first and second surfaces 202 and 204 of the platform 200 using any suitable means known to those skilled in the art.

The mounting plate body 106 is sized and shaped to facilitate load transfer from the ladder 104 to the platform 200 at an oblique angle to the direction of the downward load force exerted on the ladder 104. In the example embodiment, the first and second surfaces 108 and 110 of the mounting plate body 106 are rectangular in shape and have a suitable length and width to facilitate the load transfer. Each of the first and second surfaces 108 and 110 may have the same width W, which may be between 20 and 30 inches, such as about 26.5 inches. The first surface 108 may have a length L₁ that extends over the first platform surface 202 and the second surface 110 may have a length L₂ that extends over the second platform surface 204. In this example, the length L₂ of the second surface 110 is greater than the length L₁ of the first surface 108. In other embodiments, the first and second surfaces 108 and 110 may have any length and/or width, or any shape, that is suitable to facilitate load transfer of the downward load force exerted on the ladder 104. Moreover, in the example embodiment, the plate body 106 is a single-piece structure such that the first and second surfaces 108 and 110 are integral with one another and merge at a corner of the plate body 106. In other embodiments, the plate body 106 may be formed of two or more pieces, and the first and second surfaces 108 and 110 may be joined and secured together using any suitable means known in the art.

The mounting plate 102 also includes a pair of brackets 116 attached to the first surface 108 of the body 106. The term “attached” as used herein to describe the connection between the brackets 116 and the first surface 108 means that the brackets 116 may be separate structures that are secured to the first surface 108 (e.g., via bolts, welding, or any other suitable means known in the art), or that the brackets 116 may be integrally formed with the first surface of the body 106. The brackets 116 are spaced apart from one another a distance along the first surface 108. In this example, the brackets 116 are located on opposite sides of the first surface 108. In the example embodiment, the brackets are L-shaped and have holes 118 extending through a first portion 119. The holes 118 align with the holes 112 formed on the same side of the first surface 108 of the body 106 and receive the fasteners to secure the mounting plate 102 to the platform 200 as described above. The fasteners may be used to also secure the brackets 116 to the first surface 108. The brackets 116 include a second portion 121 extending perpendicularly outward from the first portion 119 and from the first surface 108. The second portion 121 includes a center hole 120 and a locking hole 122, each extending from an outer surface 124 of the second portion 121 through an inner surface 126. The center hole 120 receives a fastener, such as a hex female-male bolt, that enables a rotatable connection between the bracket 116 and an end of the ladder 104, described in further detail below.

The mounting plate 102 also includes locking assemblies 128 that each engage one of the brackets 116 to selectably lock the ladder 104 in a desired rotated position (e.g., in a raised position or a lowered position, described in further detail below). In some embodiments, the mounting plate 102 may include one locking assembly 128 that engages the locking hole 122 of one of the brackets 116. Each locking assembly 128 includes a barrel 130 attached (e.g., welded) to the outer surface 124 of the respective bracket 116. The barrel 130 includes a center bore extending through the barrel 130, and the center bore aligns with the locking hole 122. The locking assembly 128 also includes a T-pin 132 that is received by the barrel 130 through the center bore, and the T-pin 132 engages the locking hole 122 of the bracket 116. The T-pin 132 may be threadedly attached to the barrel 130 and is spring-loaded to enable a user to bias the T-pin 132 between an engaged and released position. Alternatively, the T-pin 132 may separate from the barrel 130 and a user may insert the T-pin 132 into the barrel 130 to engage the locking hole 122 to selectably lock the ladder 104 in a desired rotated position, and remove the T-pin 132 from the barrel 130 to selectably release the ladder 104 from the locked position.

Referring now to FIG. 3, the ladder 104 includes a pair of legs 134a and 134b. The legs 134a,b have substantially identical, mirror-image construction. Each leg 134a,b extends from a first end 136a,b to a second end 138a,b and each leg 134a,b includes an outer side surface 140a,b and an inner side surface 142a,b. The inner side surfaces 142a and 142b are oriented toward one another when the ladder 104 is assembled. Each leg 134a,b also includes a front surface 144a,b, a back surface 146a,b, and a lip 148a,b at the first end 136a,b. The lip 148a,b protrudes inward at the first end 136a beyond the back surface 146a,b in a direction opposite the front surface 144a,b. Each leg 134a,b also includes an edge surface 150a,b, and the edge surface 150a,b defines a top edge of the respective leg 134a,b when the ladder 104 is assembled and in a lowered position, described in further detail below. The front surface 144a,b is joined to the edge surface 150a,b at the first end 136a,b. The lip 148a,b is located between the back surface 146a,b and the edge surface 150a,b at the first end 136a,b.

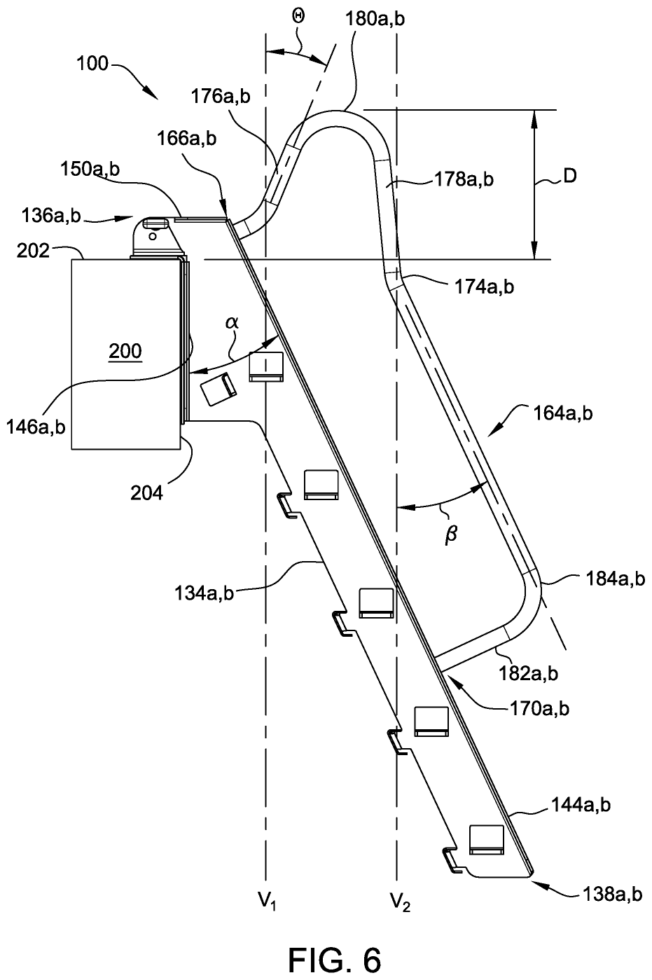

The back surface 146a,b is substantially flat and extends from the lip 148a,b toward the second end 138a,b perpendicular to the edge surface 150a,b. In the example embodiment, the front surface 144a,b slopes outwardly relative to the back surface 146a,b at an angle α (shown in FIG. 6) as each leg 134a,b extends from the first end 136a,b to the second end 138a,b. The slope of the front surface 144a,b causes the front surface to progressively extend away from the edge surface 150a,b toward the second end 138a,b. In other embodiments, the front surface 144a,b may be oriented parallel to the back surface 146a,b and extend perpendicular to the edge surface 150a,b.

The back surface 146a,b extends from the lip 148a,b a distance less than the total extent of the leg 134a,b between the lip 148a,b and the second end 138a,b. The front surface 144a,b extends the total extent, or a substantial portion of the total extent that is greater than the extent of the back surface, of the leg 134a,b between the edge surface 150a,b and the second end 138a,b. A first portion 135a,b of each leg 134a,b is defined by the co-extent of the front surface 144a,b and the back surface 146a,b toward the second end 138a,b. A second portion 137a,b of each leg 134a,b is defined by the continued extent of the front surface 144a,b toward second end 138a,b beyond the point where the back surface 146a,b ends. The extent of the side surfaces 140a,b and 142a,b between the front surface 144a,b and the back surface 146a,b progressively increases in the first portion 135a,b as the leg 134a,b extends toward the second end 138a,b due to the outward slope of the front surface 144a,b relative to the back surface 146a,b. Over the length of the second portion 137a,b, the extent of the side surfaces 140a,b and 142a,b inward from the front surface 144a,b is substantially constant.

Each leg 134a,b also includes a plurality of horizontal supports 152a,b and a plurality of vertical supports 154a,b. The plurality of horizontal supports 152a,b and the plurality of vertical supports 154a,b are disposed along the respective leg 134a,b, and extend inwardly from the inner side surface 142a,b of the respective leg 134a,b in a direction opposite the outer side surface 140a,b. Each horizontal support 152a of the first leg 134a pairs with a vertical support 154a, and each horizontal support 152b of the second leg 134b pair with a vertical support 154b. In addition, each pair of a horizontal support 152a and a vertical support 154b of the first leg 134a aligns with a pair of a horizontal support 152a and a vertical support 154b of the second leg 134b. It should be appreciated that the terms “horizontal” and “vertical” used to describe the supports 152a,b and 154a,b, respectively, are used for convenience of description and do not require any particular orientation of the supports.

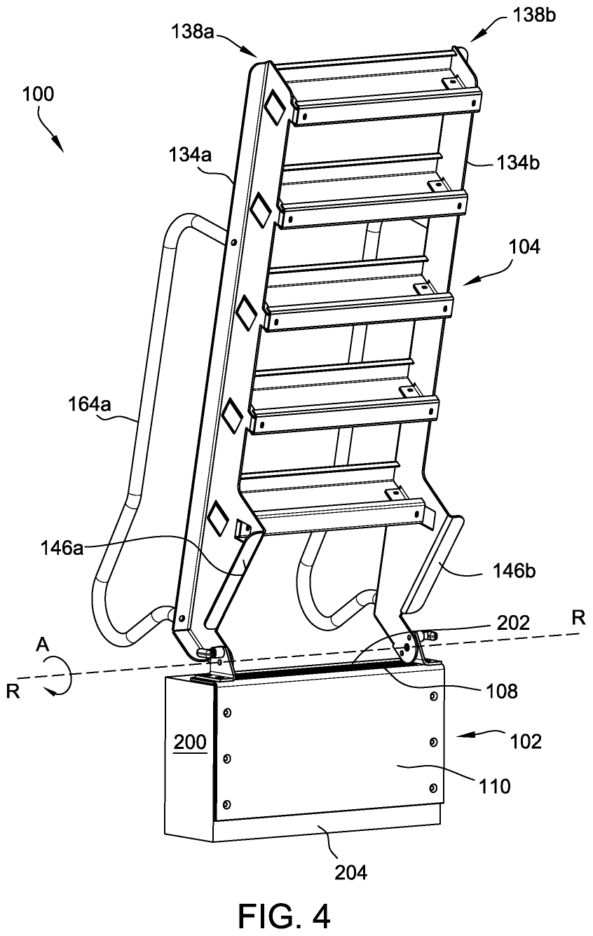

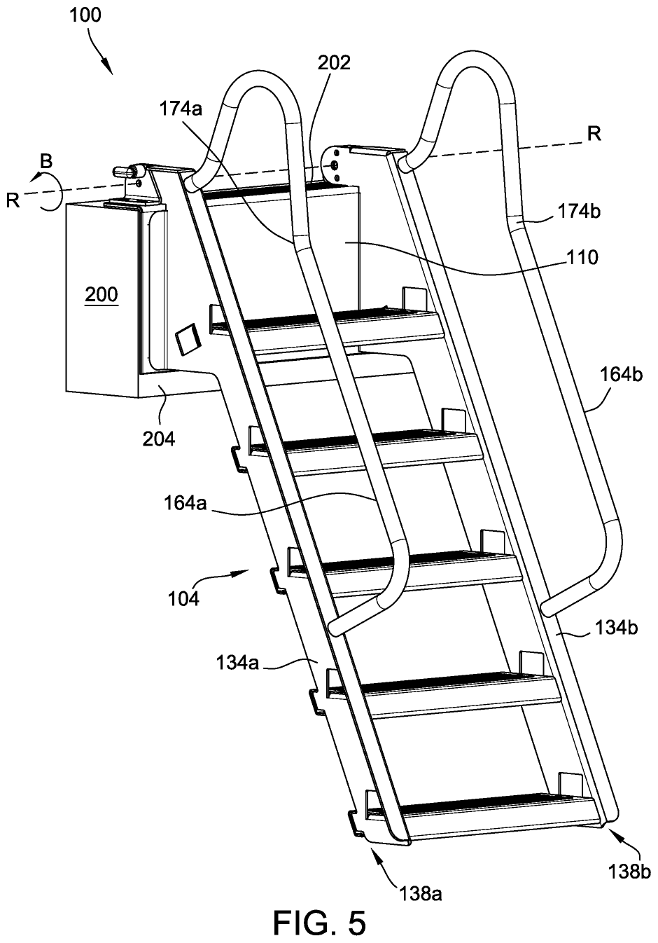

The lip 148a,b of each leg 134a,b includes a center hole 158a,b and a pair of alignment holes 160a,b and 162a,b. The alignment hole 160a,b is spaced apart from the alignment hole 160a,b. For example, the alignment hole 160a,b and the alignment hole 162a,b are located on opposite sides of the center hole 158a,b. The lips 148a,b are each connected to one of the brackets 116 to rotatably connect the ladder 104 to the mounting plate 102, and the lip 148a,b of each leg 134a,b establishes the only connection point of the respective leg 134a,b to the mounting plate 102. More specifically, in the example embodiment, the center hole 158a,b of each lip 148a,b aligns with the center hole 120 of the respective bracket 116, and the aligned center hole 120 and center hole 158a or 158b receive a suitable fastener (e.g., a hex female-male bolt) to connect the lip 148a and the lip 148b to the respective bracket 116. The fastener extends through the aligned center hole 120 and the center hole 158a or 158b, and serves as a shaft that allows each of the legs 134a,b to freely rotate about a rotational axis R (shown in FIGS. 4 and 5). To align to the center hole 120 and the center hole 158a,b, the lip 148a,b is positioned adjacent the inner surface 126 of the respective bracket 116. A spacer (e.g., a nylon bushing) may be inserted into the center hole 120 and/or the center hole 158a,b to provide space between, and facilitate preventing friction between, the lip 148a,b and the inner surface 126 of the respective bracket 116 during rotation of the leg 134a,b. As described in further detail below, the alignment hole 160a,b and the alignment hole 162a,b are configured to alternately align with the locking hole 122 of the respective bracket 116 during rotation of the leg 134a,b, and the alignment hole 160a,b and the alignment hole 162a,b are each located on the lip in a suitable position to enable the locking assembly 128 to function as described herein.

Each leg 134a,b may suitably be entirely formed, or substantially entirely formed, from a single piece of low-density metallic material (e.g., aluminum). For example, the features of each leg 134a,b described above (e.g., the outer side surface 140a,b, the inner side surface 142a,b, the front surface 144a,b, the back surface 146a,b, the edge surface 150a,b, the horizontal supports 152a,b, and the vertical supports 154a,b) may be formed from a single metal sheet comprised of recycled aluminum (e.g., 3/16″ thick, extruded sheet) and may be formed using, for example, computer numerical control (CNC) machining, or any suitable automated machining process known to those ordinarily skilled in the art. In the example embodiment, each of the plurality of horizontal supports 152a,b and each of the plurality of vertical supports 154a,b is a folded or “lanced” tab integral with the respective leg 134a,b and formed by folding material from the leg 134a,b inwardly (e.g., at a 90° bend) relative to the inner surface 142a,b in a direction opposite the outer surface 140a,b. Each of the front surface 144a,b, the back surface 146a,b, and the edge surface 150a,b are similarly integral with the respective leg 134a,b and formed by folding material from the leg 134a,b outwardly (e.g., at a 90° bend) relative to the outer side surface 140a,b in a direction opposite the inner side surface 142a,b. In this regard, the meaning of the phrase “entirely formed from a single piece of low-density metallic material,” as used herein means that the primary features of the legs 134a,b, such as those described above, are formed from the same low-density metallic material (e.g., aluminum) and integral with one another, and additional, auxiliary features may be present in the legs 134a,b that are formed from a different material without departing from the scope of the meaning of the phrase.

Each leg 134a,b may suitably be formed from low-density metallic material (e.g., aluminum) such that the ladder 104 is a light-weight ladder 104. For example, the ladder 104 may have a weight less than about 100 lbs., such as less than about 75 lbs., less than about 60 lbs., or even less than about 50 lbs. In one example, the ladder 104 weighs about 45 lbs.

When each leg 134a,b is rotatably connected to the mounting plate 102 by connecting the lip 148a,b to the respective bracket 116, legs 134a,b are spaced apart from one another due to the spacing between the brackets 116. The legs 134a,b are joined together by a plurality of transverse structures 156, which enable the ladder 104 to rotate as a fixed structure relative to the mounting plate 102, and thus the platform 200, about the rotational axis R (shown in FIGS. 4 and 5). The transverse structures 156 extend between and are supported transversely between the inner side surface 142a of the first leg 134a and the inner side surface 142b of the second leg 134b. In the example embodiment, the transverse structures 156 are steps 156 of the ladder 104. The ladder 104 includes any suitable number of steps 156, for example, three steps 156, four steps 156, or five steps 156. When the ladder 104 is assembled and oriented for use, each step 156 has a horizontal top 158 and a pair of sides 160 extending downward from the top 158. The top 158 of each step 156 is secured (e.g., via fasteners) to one of the horizontal supports 152a of the first leg 134a and an aligning horizontal support 152b of the second leg 134b. One of the sides 160 of each step 156 is secured (e.g., via fasteners) to the vertical support 154a,b of each leg 134a,b that is paired with the horizontal support 152a,b secured to the top 158 of the step 156. Each step 156 may also include material that folds over the vertical supports 154a,b secured to the side 160 to provide further structural support. When the steps 156 are secured to the first and second legs 134a,b, the steps 156 join the first and second legs 134a,b such that the legs 134a,b are locked in parallel relation to one another.

When the ladder 104 is assembled, the top 158 of each step 156 presents a surface that supports a load. In the example embodiment, the surface is suitably in a horizontal orientation to provide a flat surface, and the surface may be a treaded surface to facilitate preventing a user from slipping when using the ladder 104. It should be appreciated that the legs 134a,b can be joined by and support any type of transverse structure suitable for various uses, and the scope of the subject matter encompassed by the present disclosure is not limited to the specifically disclosed embodiments. For example, the steps 156 may instead be transverse members sized and shaped to support a ramp surface extending the length of the first and second legs 134a,b.

The steps are arranged in a similar orientation to the front surfaces 144a,b of the legs 134a,b. Thus, in the example embodiment, the steps are arranged at the acute angle α (shown in FIG. 6) measured relative to the back surface 146a,b. The angle α facilitates safe and relatively effortless movement to and from any platform 200, such as entering and exiting water using the ladder 104, for various types of users (e.g., children and dogs). The angle α may be between about 15° and about 45°, such as between about 20° and about 30°, or about 25°.

The ladder 104 also includes handrails 164a,b attached to the front surface 144a,b of the respective leg 134a,b. More specifically, each handrail 164a,b has a first open, threaded end 166a,b that aligns with a first hole 168a,b on the front surface 144a,b and a second open, threaded end 170a,b that aligns with a second hole 172a,b on the front surface 144a,b. The first hole 168a,b is located on the front surface 144a,b adjacent the first end 136a,b of the leg 134a,b, and the second hole 172a,b is located at a position spaced apart from the first hole 168a,b along the front surface 144a,b toward the second end 138a,b, such as at a location proximate or adjacent the second end 138a,b. In some embodiments, the first 168a,b is located on the edge surface 150a,b at the first end 136a,b of each leg 134a,b. The aligned first hole 168a,b and first end 166a,b and the aligned second hole 172a,b and second end 170a,b receive fasteners (e.g., bolts) to attach the handrails 164a,b to the respective front surface 144a,b. Each handrail 164a,b has a tubular body that extends non-linearly and in a generally U-shaped manner between the first end 166a,b and the second end 170a,b. As explained in further detail below, each handrail has a suitable geometry to facilitate ergonomic manual rotation of the ladder 104.

Referring to FIGS. 4 and 5, the ladder 104 is rotatable relative to the mounting plate 102 about the rotational axis R between a raised position (shown in FIG. 4) and a lowered position (shown in FIG. 5). The rotational axis R is defined by the rotatable connection between the lip 148a,b of each leg 134a,b (shown in FIG. 3) and the respective bracket 116 (shown in FIG. 2). As described above, the lip 148a,b of each leg 134a,b establishes the only connection point of the respective leg 134a,b to the mounting plate 102 and, consequently, the only component of the ladder 104 that remains connected to the mounting plate 102 as the ladder rotates about the axis R between the raised position and the lowered position. The light-weight construction of the ladder 104 may facilitate the single connection point for each leg 134a,b to rotatably connect the ladder 104 to the mounting plate 102. This in turn may facilitate easier assembly of the ladder assembly 100 by a user. The rotation of the ladder 104 in a clockwise direction A is restricted to the lowered position by the back surface 146a,b of each leg 134a,b abutting the second surface 204 of the mounting plate 102. Although not specifically shown, the rotation of the ladder 104 in a counterclockwise direction B may be restricted to the raised position by contact between the handrails 164a and 164b and the top platform surface 202.

In the example embodiment, the raised position of the ladder 104 corresponds to a stored position, where the ladder 104 is oriented relative to the platform 200 such that the second end 138a,b of each leg 134a,b is located above the first platform surface 202 on one side of the rotational axis R. As such, the ladder 104 in the raised position is located outside a body of water (not shown) adjacent the platform 200. Additionally, in the raised position, the back surface 146a,b of each leg 134a,b is spaced apart from the second surface 110 of the mounting plate 102 and the back surfaces 146a,b are each oriented in the same general direction of the second surface 110. The lowered position corresponds to an in-use position of the ladder 104, where the ladder 104 is oriented relative to the platform 200 such that the second end 138a,b of each leg 134a,b is located below the first platform surface 202 on the side of the rotational axis R opposite the side the second end 138a,b is located in the raised position. As such, in the lowered position, the second end 138a,b and at least partially the second portion of each leg 134a,b is immersed in the body of water adjacent the platform 200. Additionally, in the lowered position, the back surface 146a,b of each leg 134a,b abuts the second surface 110 of the mounting plate 102. More specifically, the back surface 146a,b of each leg 134a,b defines a planar surface that is in face-to-face contact with a planar surface defined by the second surface 110 of the mounting plate. Contact between the back surfaces 146a,b and the second surface 110 limits the rotation of the ladder 104 in a clockwise direction A, and the back surfaces 146a,b facilitate load transfer from the ladder 104 to the mounting plate 102 and, accordingly, to the platform 200 to which the mounting plate 102 is secured, at an oblique angle to the direction of the downward load force exerted on the ladder 104. Suitably, the back surfaces 146a,b and second surface 110 are sized and shaped to provide an enlarged lateral surface area to transfer loading forces on the ladder 104 to the mounting plate 102. In the example embodiment, the back surfaces 146a,b and the side surface 110 are each substantially flat and vertically oriented when the mounting plate 102 is secured to the platform 200 and the ladder 104 is in the lowered position.

In some embodiments, to allow for more rotation in a counterclockwise direction B, each handrail 164a,b may include a hinge assembly (not shown) at a respective inflection point 174a,b (described in further detail below). The hinge assembly enables the handrail 164a,b to collapse when the ladder 104 is rotated to the raised position. Additionally or alternatively, the first end 166a,b of each handrail 164a,b may be hingedly and/or removably connected to the first hole 168a,b on the front surface 144a,b (or edge surface 150a,b) of the respective leg 134a,b to facilitate the collapse of the handrail 164a,b when the ladder 104 is rotated to the raised position.

During rotation of each of the legs 134a,b, the alignment hole 160a,b and the alignment hole 162a,b of the lip 148a,b (shown in FIG. 3) alternately aligns with the locking hole 122 of the respective bracket 116 (shown in FIG. 2). The T-pin 132 may be biased, or inserted into the barrel 130, to engage the aligned locking hole 122 and alignment hole 160a,b or alignment hole 162a,b to selectably lock the ladder 104 in a desired rotated position. In this regard, the alignment hole 160a,b and the alignment hole 162a,b are each appropriately located on the lip 148a,b so that, when the locking hole 122 is aligned with the alignment hole 160a,b, the ladder 104 is oriented in a first desired position (e.g., the raised position) and, when the locking hole 122 is aligned with the alignment hole 162a,b, the ladder 104 is oriented in a second desired position (e.g., the lowered position). Thus, the T-pin 132 may be biased, or inserted into the barrel 130, when the ladder 104 is in the raised position or in the lowered position to lock the ladder 104 in the respective position. Moreover, it should be appreciated that any number of alignment holes may be included on the respective lip 148a,b depending on the number of positions in which the ladder 104 is desired to be locked, and the alignment holes are appropriately located on the lip 148a,b based on the respective desired orientation of the ladder 104 in each position.

Additionally, because the ladder 104 is suitably lightweight, a low-power rotary actuator (not shown) may be used to facilitate rotation of the ladder 104 about the rotational axis R. In some embodiments, the low-power rotary actuator may be attached to the lip 148a,b of each leg 134a,b or to the fastener (not shown) that extends through the aligned center hole 120 of each bracket 116 and the center hole 158a or 158b of the respectively connected lip 148a,b. The low-power rotary actuator may be, for example, a servo motor. The low-power rotary actuator may be powered using any suitable power source. For example, the power source may include, without limitation, a solar-powered battery source. For example, the low-power rotary actuator may include a photovoltaic panel.

In some embodiments, ladder 104 may be rotated about the rotational axis R by applying a force to the handrails 164a,b. For example, a user may pull back, or push forward, on handrails 164a,b to rotate ladder 104 between the raised position and lowered position. Because the ladder 104 is suitably lightweight, the amount of force required to be applied to handrails 164a,b to raise and/or lower ladder 104 is relatively low and, as such, manual rotation may be performed by various types of users with different strengths.

Referring to FIG. 6, the handrails 164a,b each have a first segment 176a,b extending outward from the first end 166a,b that is connected to the front surface 144a,b (or the edge surface 150a,b) of the leg 134a,b adjacent the first end 136a,b, to a second segment 178a,b. The first segment 176a,b and the second segment 178a,b are joined at a top arc 180a,b, and the second segment 178a,b extends a length of the leg 134a,b toward a third segment 182a,b. The second segment 178a,b and the third segment 182a,b are joined at a bottom arc 184a,b, and the third segment 182a,b extends to the second end 170a,b connected to the front surface 144a,b of the leg 134a,b. second location 224 on the front edge 220.

In the example embodiment, the handrails 164a,b are ergonomically designed with a geometry that facilitates manual rotation of the ladder 104. The first segment 176a,b may be used to rotate the ladder 104 from the lowered position to the raised position by applying a pulling force. The first segment 176a,b has a first portion that extends from the front surface 144a,b in a direction perpendicular to the front surface 144a,b. In another example, the first portion of the first segment 176a,b extends from the edge surface 150a,b and perpendicular to the edge surface 150a,b, along a vertical axis V₁ when the ladder 104 is in the lowered position. The first segment 176a,b diverges at an inflection point 186a,b to a second portion that extends from the first portion of the first segment 176a,b to the top arc 180a,b at an oblique angle θ measured relative to the vertical axis V₁. Angle θ may be from about 10° to about 40°. In the example embodiment, angle θ is about 25°. The top arc 180a,b is located a vertical distance D from the first platform surface 202 when the ladder 104 is in the lowered position. The distance D may be from about 20 inches to about 40 inches, such as about 30 inches. The second segment 178a,b may be used to guide the ladder 104 during rotation to the raised position, and also to rotate the ladder 104 to the lowered position from the raised position by applying a pushing force. The second segment 178a,b extends downward from top arc 180a,b when the ladder 104 is in the lowered position, and the second segment 178a,b includes a first portion oriented substantially along vertical axis V₂ and the first portion extends from the top arc 180a,b substantially perpendicular to the edge surface 150a,b. The second vertical axis V₂ is oriented parallel to the first vertical axis V₁. The second segment 178a,b diverges from the first portion at inflection point 174a,b at an oblique angle β measured relative to the second vertical axis V₂ and outward relative to top arc 180a,b when the ladder 104 is in the lowered position. The second portion of the second segment 178a,b is also oriented substantially parallel with the front surface 144a,b of the respective leg 134a,b. Angle β may be from about 10° to about 40°. In the example embodiment, angle β is about 25°. In the example embodiment, inflection point 174a,b is located below the edge surface 150a,b when the ladder 104 is in the lowered position. The second portion of the second segment 178a,b extends to the bottom arc 184a,b. The third segment 182a,b extends from the bottom arc 184a,b to the second end 170a,b, and the third segment 182a,b is oriented substantially perpendicular to the second portion of the second segment 178a,b. In the example embodiment, the handrail 164a,b is shaped such that the angle θ is substantially the same as the angle β. In other embodiments each handrail 164a,b may have any shape that facilitates manual rotation of the ladder 104 using the handrail 164a,b.

In one embodiment, the ladder assembly 100 may be provided as a kit that includes components of the mounting plate 102 and the ladder 104 as separate parts for assembly by a user. More specifically, the kit includes the mounting plate 102, the brackets 116, the legs 134a,b, the steps 156, the handrails 164a,b, and the locking assemblies 128. The kit may include the brackets 116 attached (e.g., welded) to the mounting plate 102, or alternatively the kit may include the brackets 116 separate from the mounting plate 102 for attachment by the user. The kit may include the barrels 130 of the locking assemblies 128 attached (e.g., welded) to the outer surface 124 of the respective bracket 116, or alternatively the kit may include the barrels 130 separate from the brackets 116 for attachment by the user. The kit also may include fasteners suitable for the various connections between the components as described above.

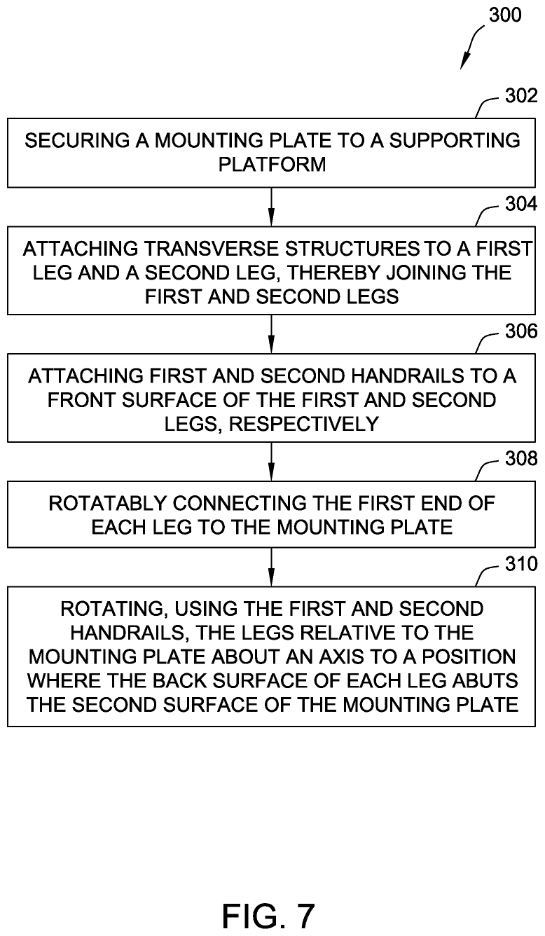

Referring to FIG. 7, a flowchart of an example method 300 for assembling the ladder assembly 100 is shown. The method 300 includes securing 302 the mounting plate 102 to a supporting platform, such as platform 200. As described above, the mounting plate 102 includes a body 106 that is sized and shaped to be mounted onto the platform 200. The body 106 has a first planar surface 108 and a second planar surface 110, the first and second surfaces 108 and 110 oriented in different directions. The mounting plate 102 also includes a pair of spaced apart brackets 116 attached to the first surface 108. In some embodiments, the method 300 includes attaching the brackets 116 at spaced apart locations on the first surface 108. Each of the first and second surfaces 108 and 110 include a plurality of holes 112 that extend through the body 106 and align with holes formed (e.g., drilled) into first and second platform surfaces 202 and 204 (and/or structural steel supports of the platform). The aligning holes receive fasteners to secure 302 the mounting plate 102 to the platform 200 at suitable locations for proper load distribution.

The method 300 also includes attaching 304 a plurality of transverse structures 156 to a first leg 134a and a second leg 134b, thereby joining the first and second legs 134a,b together. The transverse structures 156 may be steps 156, for example, and attaching 304 the steps 156 to each leg 134a,b thereby forms a ladder 104. As described above, each leg 134a,b extends from a first end 136a,b to a second end 138a,b, and each leg has a front surface 144a,b and an opposing back surface 146a,b. Each leg 134a,b also includes an outer side surface 140a,b and an inner side surface 142a,b. When the transverse structures are attached to each leg 134a,b, the inner side surface 142a is oriented toward the inner side surface 142b. Each leg 134a,b also includes a plurality of horizontal supports 152a,b and a plurality of vertical supports 154a,b are disposed along the respective leg 134a,b. The supports 152a,b and 154a,b and extend inwardly from the inner side surface 142a,b of the respective leg 134a,b in a direction opposite the outer side surface 140a,b, and each transverse structure 156 is secured to one of each of the supports 152a, 154a, 152b, and 154b, to provide transverse support for the structure 156 between the legs 134a and 134b.

The method 300 also includes attaching 306 first and second handrails 164a,b to the front surface 144a,b of the first and second legs 134a,b, respectively. As described above, each handrail 164a,b extends non-linearly and generally in a U-shaped manner between a first end 166a,b attached to the front surface 144a,b (or to an edge surface 150a,b) adjacent the first end 136a,b of the respective leg 134a,b and a second end 170a,b attached to the front surface 144a,b at a point spaced from the first end 136a,b toward the second end 138a,b of the respective leg 134a,b. Each end 166a,b and 170a,b may be attached to the respective leg 134a,b using a suitable fastener (e.g., bolts). The handrails 164a,b are suitably formed with an ergonomic geometry to enable manual rotation of the ladder 104, as described above.

The method 300 further includes rotatably connecting 308 the first end 136a,b of each leg 134a,b to a respective one of the brackets 116 attached to the first surface 108 of the mounting plate 102. Thereby, the ladder 104 is rotatable relative to the mounting plate 102 about the rotational axis R between the raised position (shown in FIG. 4) and the lowered position (shown in FIG. 5). Each leg 134a,b has a lip 148a,b extending outward beyond the back surface 146a,b, and each lip has a center hole 158a,b that aligns with a center hole 120 of a respective bracket 116. The aligned center hole 120 and center hole 158a or 158b receive a fastener (e.g., a hex female-male bolt) that serves as a shaft that allows each of the legs 134a,b to freely rotate about the rotational axis R

The method 300 also includes rotating 310, using the first and second handrails 164a,b, the legs 134a,b relative to the mounting plate 102 about the rotational axis R to the lowered position, where the back surface 146a,b of each leg 134a,b abuts the second surface 110 of the mounting plate 102. As described above, the back surfaces 146a,b and second surface 110 are suitably sized and shaped to provide an enlarged lateral surface area to transfer loading forces on the ladder 104 to the mounting plate 102. In the example embodiment, the back surfaces 146a,b and the side surface 110 are each substantially flat and vertically oriented when the mounting plate 102 is secured to the platform 200 and the ladder 104 is in the lowered position.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

When introducing elements of the present disclosure or the embodiment(s) thereof, the articles “a”, “an”, “the” and “said” are intended to mean that there are one or more of the elements. The terms “comprising,” “including,” “containing” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the disclosure, it is intended that all matter contained in the above description and shown in the accompanying drawing[s] shall be interpreted as illustrative and not in a limiting sense.

What is claimed is:

1. A ladder assembly comprising:
a mounting plate adapted to be secured to a supporting platform, the mounting plate comprising a body, the body including a first planar surface having a first orientation and a second planar surface having a second, different orientation, the mounting plate further comprising a pair of spaced apart brackets attached to the first surface; and
a ladder connected to the mounting plate and rotatable relative to the mounting plate about an axis, the ladder comprising:
a first leg and a second leg, each leg extending from a first end to a second end, each leg rotatably connected to one of the brackets at the first end, wherein each leg has opposing side surfaces and opposing front and back surfaces;
a plurality of steps supported transversely between a side surface of the first leg and a side surface of the second leg, wherein the steps join the first and second legs; and
a handrail attached to the front surface of the first leg;
wherein the ladder is rotatable between a first position, where the back surface of each leg abuts the second surface of the mounting plate body, and a second position, where the back surface of each leg is spaced from the second surface of the mounting plate body.

2. The ladder assembly of claim 1, wherein the ladder comprises a first handrail attached to the front surface of the first leg and a second handrail attached to the front surface of the second leg, wherein each of the first and second handrails comprises a first segment extending from the front surface of the respective leg proximate the first end to a second segment, the second segment extending along a length of the respective leg to a third segment, the third segment extending toward the front surface of the respective leg proximate the second end.

3. The ladder assembly of claim 2, wherein the first segment enables rotation of the ladder from the first position to the second position, and wherein the second segment enables rotation of the ladder from the second position to the first position.

4. The ladder assembly of claim 1, wherein the mounting plate body is L-shaped such that the first surface is perpendicular to the second surface, and wherein the first and second orientations are each perpendicular to the axis.

5. The ladder assembly of claim 1, wherein, in the first position, the back surface of each leg is in face-to-face contact with the second surface of the mounting plate body, and wherein, in the second position, the back surface of each leg is in face-to-face contact with the second surface of the mounting plate body.

6. The ladder assembly of claim 1, wherein, in the second position, the back surface of each leg and the second surface of the mounting plate face the same direction.

7. The ladder assembly of claim 1, further comprising at least one locking pin that engages at least one of the brackets and the first end of at least one of the legs connected to the at least one of the brackets to selectably lock the ladder in the first position or the second position.

8. The ladder assembly of claim 1, wherein each leg comprises a lip at the first end extending beyond the back surface in a direction opposite the front surface, wherein the lip is rotatably connected to the respective bracket.

9. The ladder assembly of claim 8, wherein the lip of each leg establishes the only connection point of the respective leg to the mounting plate as the ladder is rotated about the axis.

10. The ladder assembly of claim 8, wherein the back surface of each leg extends perpendicular to the lip.

11. The ladder assembly of claim 1, wherein the front surface of each leg slopes outwardly relative to the back surface as each leg extends from the first end to the second end.

12. The ladder assembly of claim 11, wherein the steps are arranged at an acute angle measured relative to the back surface.

13. The ladder assembly of claim 1, wherein each leg includes a plurality of support tabs integral with the side surface that supports the steps, each support tab folded inwardly from the side surface, wherein each step is fastened to one of the support tabs of each leg.

14. The ladder assembly of claim 1, wherein the ladder weighs less than 75 lbs.

15. The ladder assembly of claim 1, wherein the ladder weighs 45 lbs.

16. The ladder assembly of claim 1, wherein each leg is formed from a single piece of low-density metallic material.

17. A kit for a ladder assembly, the kit comprising:
a mounting plate adapted to be secured to a supporting platform, the mounting plate comprising a body, the body including a first planar surface having a first orientation and a second planar surface having a second, different orientation, the mounting plate further comprising a pair of spaced apart brackets attached to the first surface;
first and second legs of a ladder, each leg extending from a first end to a second end and having opposing side surfaces and opposing front and back surfaces, each leg comprising a lip extending outward from the back surface at the first end, the lip rotatably attachable to one of the spaced apart brackets; and
steps for joining the first and second legs of the ladder.

18. The kit of claim 17, further comprising locking pins each engageable with one of the brackets and the lip of the respective leg connected to the one of the brackets to selectably lock the ladder in a rotated position.

19. The kit of claim 17, further comprising a handrail having a first segment attachable to the front surface of the first leg proximate the first end, the first segment extending in a first direction to a second segment, the second segment extending in a second direction other than the first direction to a third segment, the third segment attachable to the front surface of the first leg proximate the second end and extending in a third direction other than the second direction.

20. A method for assembling a ladder assembly, the method comprising:
securing a mounting plate to a supporting platform, the mounting plate comprising a body, the body including a first planar surface having a first orientation and a second planar surface having a second, different orientation, the mounting plate further comprising a pair of spaced apart brackets attached to the first surface;
attaching a plurality of transverse structures to each of a first leg and a second leg, thereby joining the first and second legs together, each leg extending from a first end to a second end and having a front surface and an opposing back surface;
attaching a handrail to the front surface of the first leg;
rotatably connecting the first end of each leg to a respective one of the brackets; and
rotating the legs relative to the mounting plate about an axis to a position where the back surface of each leg abuts the second surface of the mounting plate.
